(19) United States
(12) Patent Application Publication
(10) Pub. No.: US 2016/0108801 A1
(43) Pub. Date: Apr. 21, 2016

(54) TURBOCHARGER CONTROL

(71) Applicant: INTERNATIONAL ENGINE INTELLECTUAL PROPERTY COMPANY, LLC, Lisle, IL (US)

(72) Inventors: Daniel Cornelius, Chicago, IL (US); Shree Charan Kanchanavally, Naperville, IL (US); Jeremy Grant Schipper, Chicago, IL (US)

(73) Assignee: INTERNATIONAL ENGINE INTELLECTUAL PROPERTY COMPANY, LLC, Lisle, IL (US)

(21) Appl. No.: 14/893,562

(22) PCT Filed: May 29, 2013
(86) PCT No.: PCT/US13/43064

§ 371 Date: Nov. 24, 2015

(51) Int. Cl. F02B 37/14

(52) U.S. Cl. CPC F02B 37/14

(57) ABSTRACT

A rotary device is coupled to the rotary mechanism of a turbocharger for selectively adding torque to and subtracting torque from the rotary turbocharger mechanism. A controller causes the rotary device to apply torque to the rotary turbocharger mechanism which causes the compressor to operate at a power level which creates a target pressure in the intake manifold different from existing pressure in the intake manifold.

### TECHNICAL FIELD

This disclosure relates to turbocharged (either single- or multiple-stage) internal combustion engines, especially engines of the type for propelling motor vehicles.

### BACKGROUND

A turbocharged internal combustion engine comprises a turbocharger having a turbine operated by engine exhaust passing through an engine exhaust system and a compressor operated by the turbine for elevating pressure in an intake manifold to super-atmospheric pressure. Turbocharging allows a larger quantity of fresh air to be introduced into an engine cylinder for supporting combustion of an increased quantity of fuel in the cylinder, thereby increasing the power output of the engine.

Engine engineers are familiar with a phenomenon called “turbo lag” which is inherent in turbochargers. Because a rotary mechanism of a turbocharger becomes effective at rather high rotational speeds, acceleration to those speeds typically takes some amount of time which is not necessarily insignificant, and when that occurs, a turbocharger is said to experience turbo lag. Turbo lag can impair the ability of an engine to quickly respond to transient changes in operation. Various factors affect the severity of turbo lag.

### SUMMARY OF THE DISCLOSURE

A rotary device is associated with a turbocharger of an internal combustion engine which comprises engine cylinders within which fuel is combusted to operate the engine, an intake system, including an intake manifold, through which air enters the engine cylinders to support combustion, an exhaust system through which exhaust resulting from combustion leaves the engine cylinders, and a turbocharger having a turbine in the exhaust system, a compressor in the intake system, and a rotary turbocharger mechanism operated by exhaust flow through the turbine for operating the compressor to compress air flow through the intake system and create pressure in the intake manifold exceeding ambient atmospheric pressure.

The rotary device is coupled to the rotary turbocharger mechanism for selectively adding torque to and subtracting torque from the rotary turbocharger mechanism.

As the engine operates, an engine controller processes data representing certain engine operating parameters according to an algorithm for calculating a quantity of power which the rotary drive is to selectively add to or subtract from power being produced by the turbine to cause the compressor to operate at a power level which creates a target pressure in the intake manifold different from existing pressure in the intake manifold.

The controller then causes the rotary device to apply torque to the rotary turbocharger mechanism which causes the compressor to operate at the power level which creates the target pressure in the intake manifold different from existing pressure in the intake manifold.

The controller provides a method of turbocharging the engine by processing data representing certain engine operating parameters according to the algorithm for calculating a quantity of power which the rotary drive is to selectively add to or subtract from power being produced by the turbine to cause the compressor to operate at a power level which creates a target pressure in the intake manifold different from existing pressure in the intake manifold, and by then causing the rotary device to apply torque to the rotary turbocharger mechanism which causes the compressor to operate at the power level which creates the target pressure in the intake manifold different from existing pressure in the intake manifold.

The foregoing summary is accompanied by further detail of the disclosure presented in the Detailed Description below with reference to the following drawings which are part of the disclosure.

### BRIEF DESCRIPTION OF THE DRAWINGS

FIG. 1 is a general schematic diagram of an internal combustion engine having a first type of driven turbocharger configuration.

FIG. 2 is a general schematic diagram of an internal combustion engine having a second type of driven turbocharger configuration.

FIG. 3 is a general schematic diagram of an internal combustion engine having a third type of driven turbocharger configuration.

FIG. 4 is a general schematic diagram of an internal combustion engine having a fourth type of driven turbocharger configuration.

FIG. 5 is a graph plot showing, as an example of a time trace of power input/output to/from a driven turbocharger configuration.

FIG. 6 is graph plot showing an example of a time trace of indicated torque developed by a driven turbocharger and a time trace of indicated torque developed by a non-driven turbocharger during a portion of a driving cycle.

FIG. 7 is graph plot showing a time trace of intake manifold pressure developed by the driven turbocharger and a time trace of intake manifold pressure developed by the non-driven turbocharger during the same portion of a driving cycle.

FIG. 8 is graph plot showing a time trace of oxygen percentage in the intake manifold for the driven turbocharger configuration and oxygen percentage in the intake manifold for the non-driven turbocharger configuration during the same portion of a driving cycle.

FIG. 9 is graph plot showing an example of a time trace of indicated torque developed by a driven turbocharger and a time trace of indicated torque developed by a non-driven turbocharger during a different portion of a driving cycle.

FIG. 10 is graph plot showing a time trace of intake manifold pressure developed by the driven turbocharger and a time trace of intake manifold pressure developed by the non-driven turbocharger during the different portion of a driving cycle.

FIG. 11 is graph plot showing a time trace of oxygen percentage in the intake manifold for the driven turbocharger configuration and oxygen percentage in the intake manifold for the non-driven turbocharger configuration during the different portion of a driving cycle.

### DETAILED DESCRIPTION

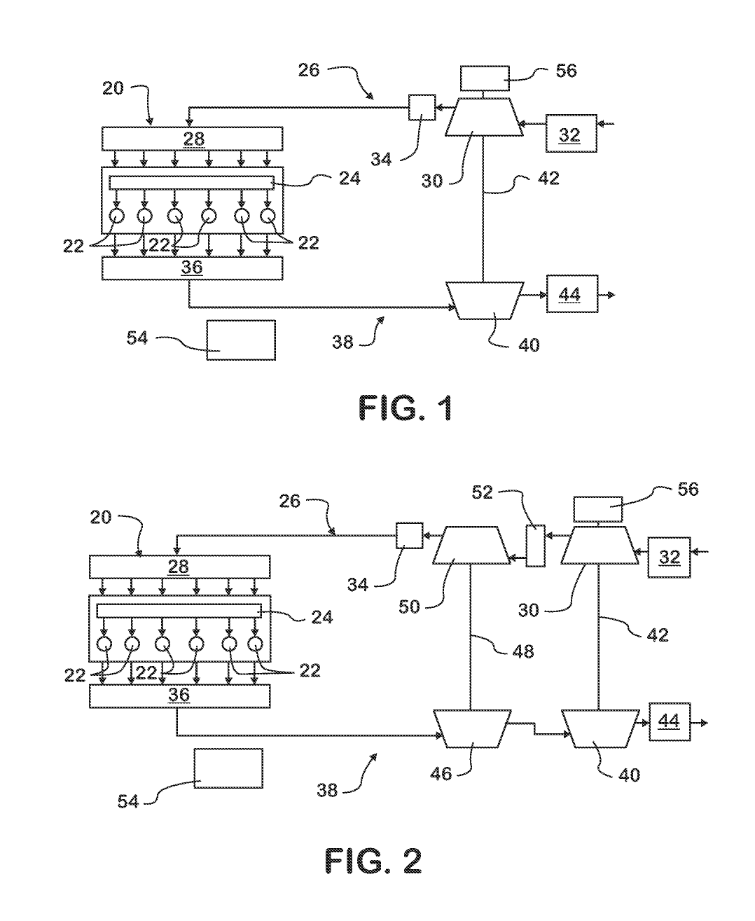

FIG. 1 shows a multi-cylinder internal combustion engine 20, a six-cylinder diesel engine for example, which comprises structure forming engine cylinders 22 into which fuel is injected by fuel injectors 24 to combust with air which has entered engine cylinders 22 through an intake system 26. Engine 20 comprises an intake manifold 28 through which air passing through intake system 26 enters engine cylinders 22 when cylinder intake valves (not shown) for controlling admission of air from intake manifold 28 into respective engine cylinders 22 are open.

Intake system 26 comprises a compressor 30 for elevating pressure in intake manifold 28 to super-atmospheric pressure, meaning pressure greater than that of ambient air pressure, i.e. creating boost air, in intake manifold 28. Compressor 30 operates to draw ambient air through a fresh air inlet 32, to compress the air, and force the compressed air through a charge air cooler 34 to cool the compressed air, and then into intake manifold 28. Other components which may be present in intake systems of contemporary diesel engines are not shown.

Engine 20 further comprises cylinder exhaust valves (not shown) for controlling admission of exhaust from respective engine cylinders 22 into an exhaust manifold 36 for further conveyance through an exhaust system 38. Exhaust system 38 includes a turbine 40 which is coupled by a shaft 42 to operate compressor 30. Other components which may be present in exhaust systems of contemporary diesel engines are not shown with the exception of an exhaust after-treatment system 44 which may comprise a diesel oxidation catalyst (DOC) and a diesel particulate filter (DPF).

Collectively, compressor 30 and turbine 40 form a single-stage turbocharger. FIGS. 2, 3, and 4 show examples of two-stage turbochargers comprising for each stage a respective turbine which is coupled by a shaft to a respective compressor. Like reference numerals designate like elements in FIGS. 1-4, with FIGS. 2, 3, and 4 showing compressor 30 and turbine 40 forming a low-pressure stage and a turbine 46 coupled by a shaft 48 to a compressor 50 forming a high-pressure stage. An inter-stage cooler 52 is disposed in intake system 26 to cool air coming from compressor 30 before the air enters compressor 50.

A processor-based engine control unit (ECU) 54 controls various aspects of engine operation, such as fueling of engine cylinders 22 by fuel injectors 24. Control is accomplished by processing various input data to ECU 54.

In each FIG. 1-4 at least one turbocharger is a driven turbocharger. A driven turbocharger is one in which a rotary device is coupled with the rotary mechanism of the turbocharger for selectively adding and subtracting torque to and from the rotary turbocharger mechanism for the purpose of controlling pressure in the intake manifold, i.e. controlling boost air, by controlling power applied to the turbocharger compressor. A rotary turbocharger mechanism comprises a turbine wheel disposed inside a turbine housing for rotation by engine exhaust passing through the turbine housing, a shaft which couples the turbine wheel to a compressor wheel inside a compressor housing to rotate the compressor wheel for compressing air passing through the compressor housing.

There are different ways for coupling a rotary device with the rotary turbocharger mechanism and the showing in the Figures of a rotary device 56 coupled to a compressor on a side of the compressor housing opposite the turbocharger shaft is intended to be merely schematic.

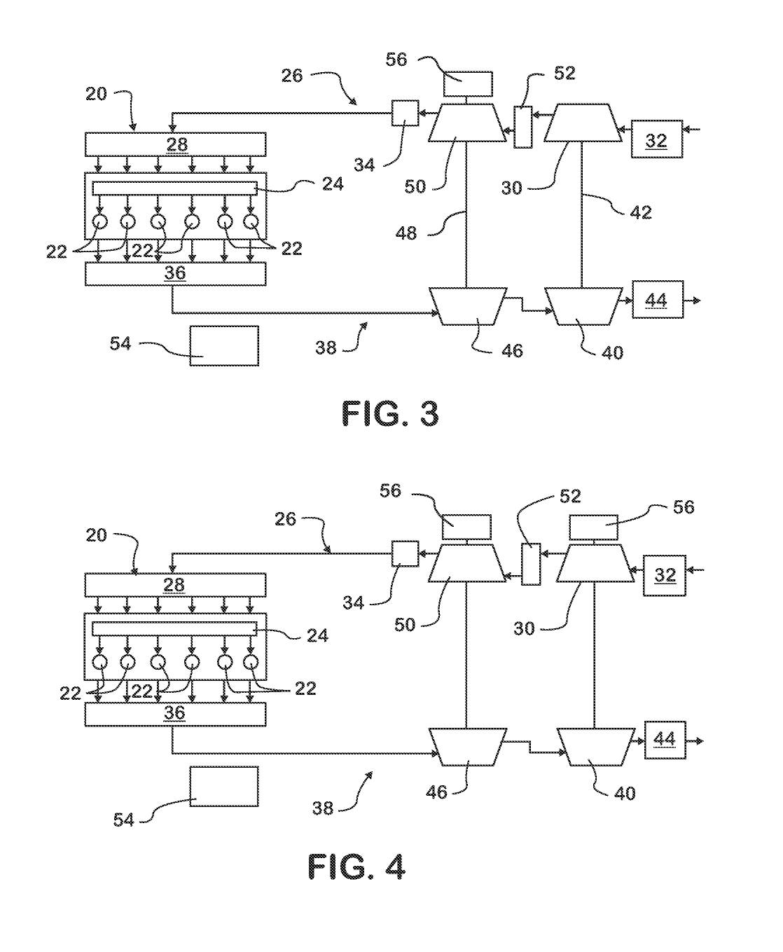

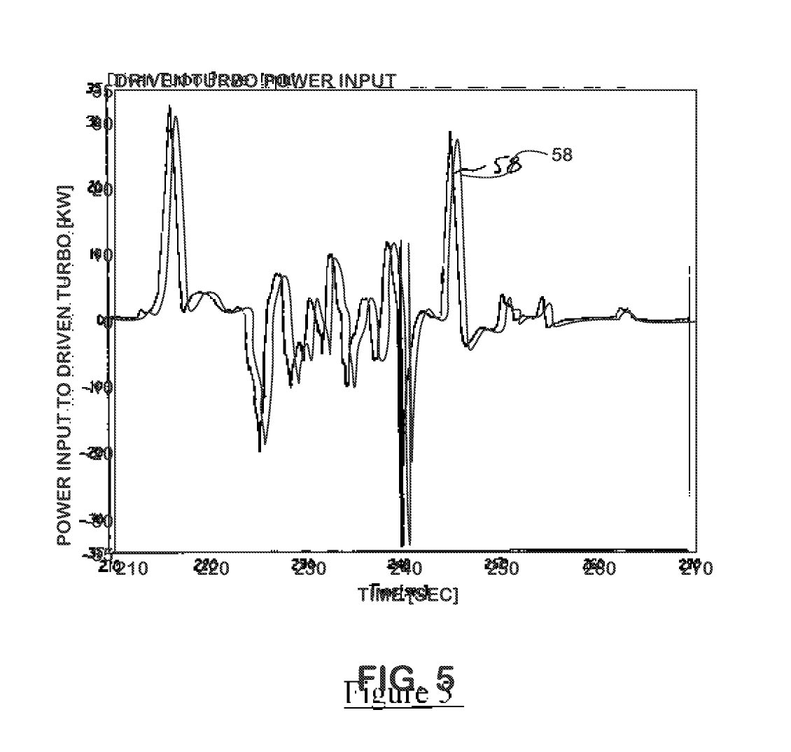

FIG. 2 shows a rotary device 56 coupled with the rotary mechanism of the low-pressure turbocharger stage. FIG. 3 shows a rotary device 56 coupled with the rotary mechanism of the high-pressure turbocharger stage. FIG. 4 shows a respective rotary device 56 coupled with the rotary mechanism of each turbocharger stage.

A rotary device 56, which can be either electrical or mechanical, is controlled by ECU 54 to selectively add and subtract torque to and from the rotary turbocharger mechanism to which it is coupled. Controlling rotary device 56 controls the power input to a turbocharger's compressor by causing the compressor to operate at a power level which creates a target boost air in the intake manifold.

Power applied to the compressor is a function of both torque applied to the compressor wheel and the compressor wheel's rotational speed. When the turbine is developing torque at a particular speed, i.e. producing a particular power output, which would cause the compressor to operate at a power level greater than that which would create a target boost air in the intake manifold, ECU 54 causes rotary device 56 to impose a load torque on the rotary turbocharger mechanism which reduces the power being applied to the compressor to a power level which produces the target boost air. When the turbine is developing torque at a particular speed which would cause the compressor to operate at a power level less than that which would create a target boost air in the intake manifold, rotary device 56 operates to contribute torque to the rotary turbocharger mechanism in a quantity which is additive to torque being produced by the turbine so as to cause the compressor to operate at a power level which creates a target boost air in the intake manifold.

A control strategy for controlling target boost air by controlling the power level at which the compressor operates can be developed during an engine developmental process. During such a process, an engine operates under different combinations of controlled conditions while measurements of various engine operating parameters are taken at each of the different combinations. Data representing the measurements is compiled and correlated to create what is sometimes called an engine map. The map is embodied electronically in ECU 54 and is utilized by a control algorithm also embodied in ECU 54. The algorithm is executed by the ECU processing data from the map and data representing various engine operating parameters which are being measured as the engine operates.

The following equations present an example of an algorithm.

$${W}_{c} = \frac{{\dot{m}}_{c} \times {C}_{p} \times {T}_{in} \times [ {( \frac{{P}_{man}}{{P}_{in}} )}^{( \frac{γ}{γ - 1} )} - 1 ]}{η}$$

$${W}_{ideal} = \frac{{\dot{m}}_{c} \times {C}_{p} \times {T}_{in} \times [ {( \frac{{P}_{target}}{{P}_{in}} )}^{( \frac{γ}{γ - 1} )} - 1 ]}{η}$$

$${W}_{required} = ( {W}_{ideal} - {W}_{c} ) \times ( Factor for Inertia )$$

W_{c} represents the power level at which the compressor is operating, W_{ideal} represents a target power level at which the compressor should be operating to create a particular target boost air for engine operating conditions which are being measured, and W_{required} represents power which must be added to or subtracted from the power at which the compressor is currently operating in order to cause the compressor to operate at a power level which will produce the target boost air.

Because power is a function of both speed and torque, and because torque which rotary device 56 may be capable of adding to or subtracting from torque being produced by the turbine may be speed-dependent, a change in power may involve a change in speed of the turbocharger's rotary mechanism. When some of the power to be added to or subtracted from the torque being produced by the turbine is used to accelerate or decelerate the rotary mechanism to a new speed, that power does not contribute to changing boost air. Consequently the difference between W_{c} and W_{ideal} must be adjusted by an inertial factor representing power involved in changing the rotary mechanism's speed to the new speed.

FIG. 5 shows an example of a time trace 58 of power input/output to/from a driven turbocharger configuration due to presence of rotary device 56 and the associated power control strategy. Positive values of power input from rotary device 56 result from causing rotary device 56 to operate as a torque source which applies accelerating torque to the turbocharger's rotary mechanism. Negative values of power input result from causing rotary device 56 to operate as a torque load on the turbine.

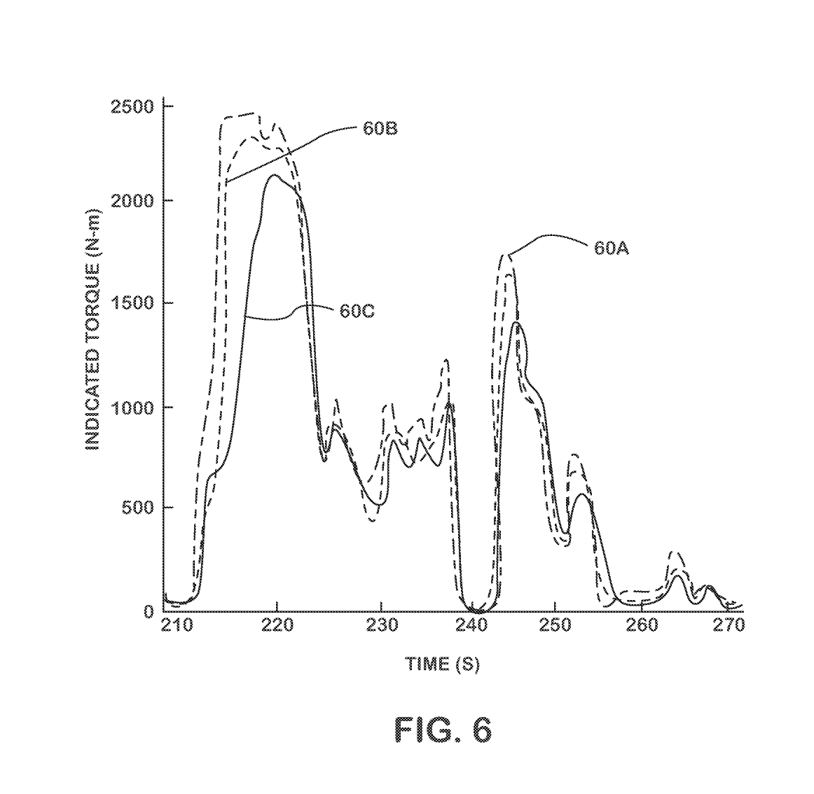

The time traces shown in FIGS. 6, 7, and 8 illustrate effectiveness of the control strategy during simulated operation of engine operation over a portion of a drive cycle of a motor vehicle which is being propelled by the engine.

In FIG. 6 a time trace 60A represents engine output torque being commanded by ECU 54. A time trace 60B represents indicated engine output torque for a driven turbocharger configuration. A time trace 60C represents indicated engine output torque for a non-driven turbocharger configuration. Comparison of traces 60B and 60C discloses that the driven turbocharger configuration provides more effective torque response.

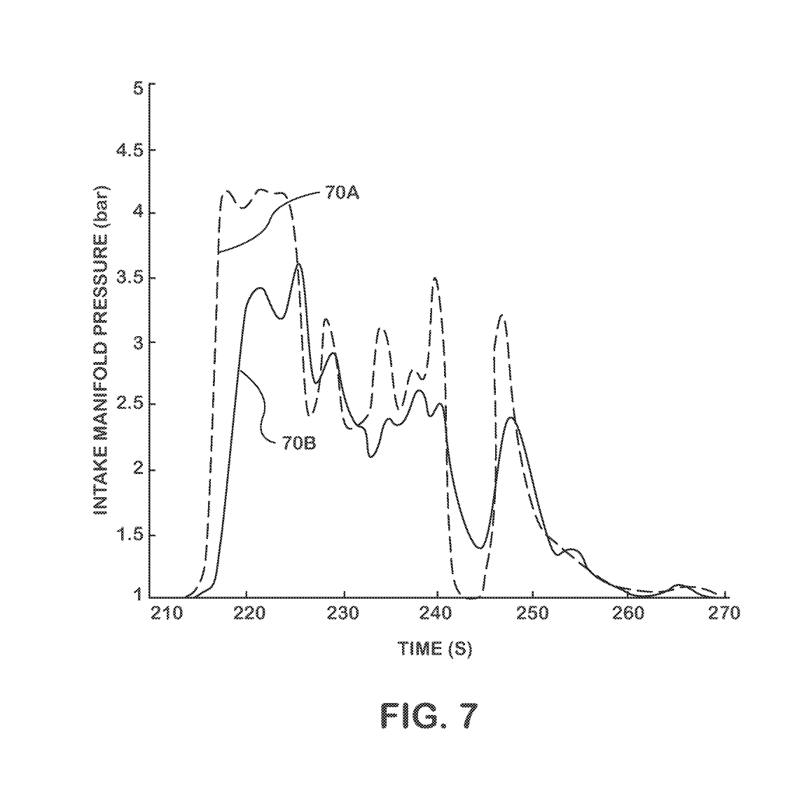

In FIG. 7 a time trace 70A represents intake manifold pressure, i.e. boost air, for the driven turbocharger configuration and a time trace 70B represents intake manifold pressure, i.e. boost air, for the non-driven turbocharger configuration. Comparison of traces 70A and 70B discloses that the driven turbocharger configuration provides more effective boost response.

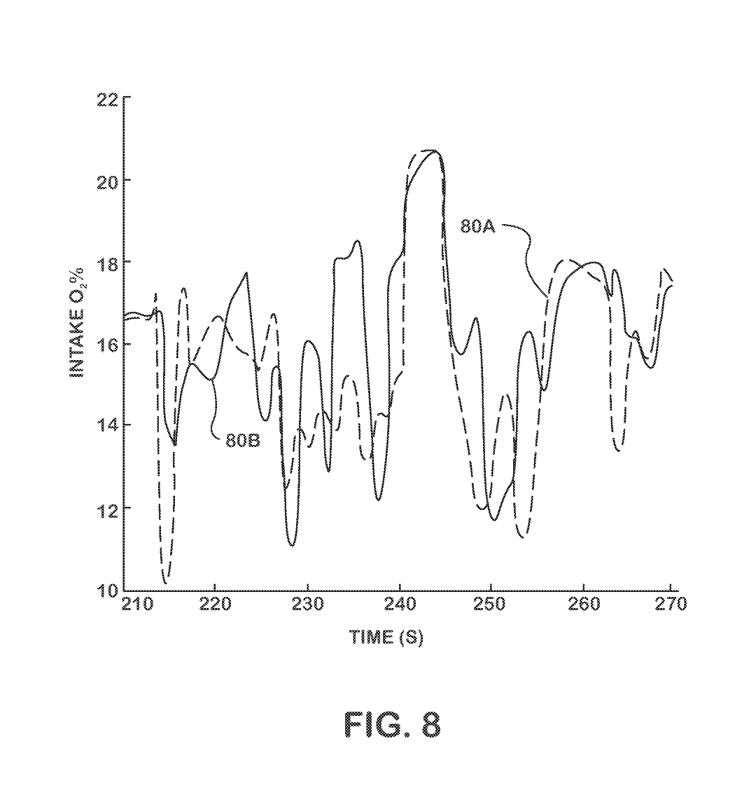

In FIG. 8 a time trace 80A represents oxygen percentage in the intake manifold for the driven turbocharger configuration and a time trace 80B represents oxygen percentage in the intake manifold for the non-driven turbocharger configuration. Comparison of traces 80A and 80B discloses that in some transient situations the driven turbocharger configuration, by drawing more power from rotary device 56 to operate the compressor, provides a lower oxygen percentage in the intake manifold because, unlike the non-driven turbocharger configuration, EGR doesn't have to be reduced or turned off in order to supply the additional power for operating the compressor. Avoiding such decreases in EGR is beneficial in mitigation of tailpipe emissions.

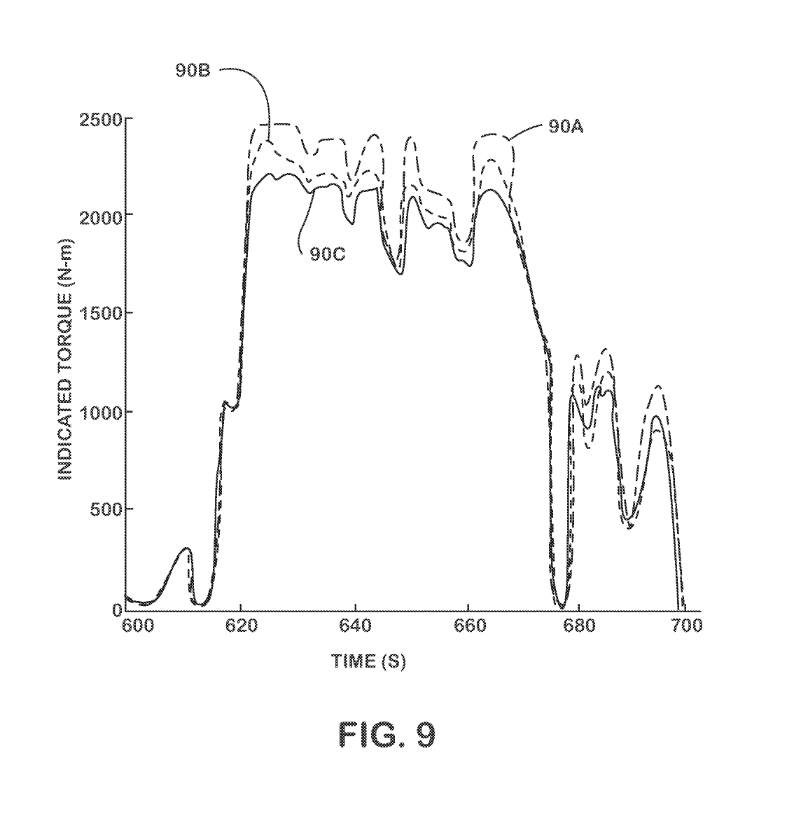

The time traces shown in FIGS. 9, 10, and 11 illustrate effectiveness of the control strategy during simulated operation of engine operation over a different portion of a drive cycle of the motor vehicle which is being propelled by the engine.

In FIG. 9 a time trace 90A represents engine output torque being commanded by ECU 54. A time trace 90B represents indicated engine output torque for a driven turbocharger configuration. A time trace 90C represents indicated engine output torque for a non-driven turbocharger configuration. Comparison of traces 90B and 90C discloses that the driven turbocharger configuration provides more effective torque response.

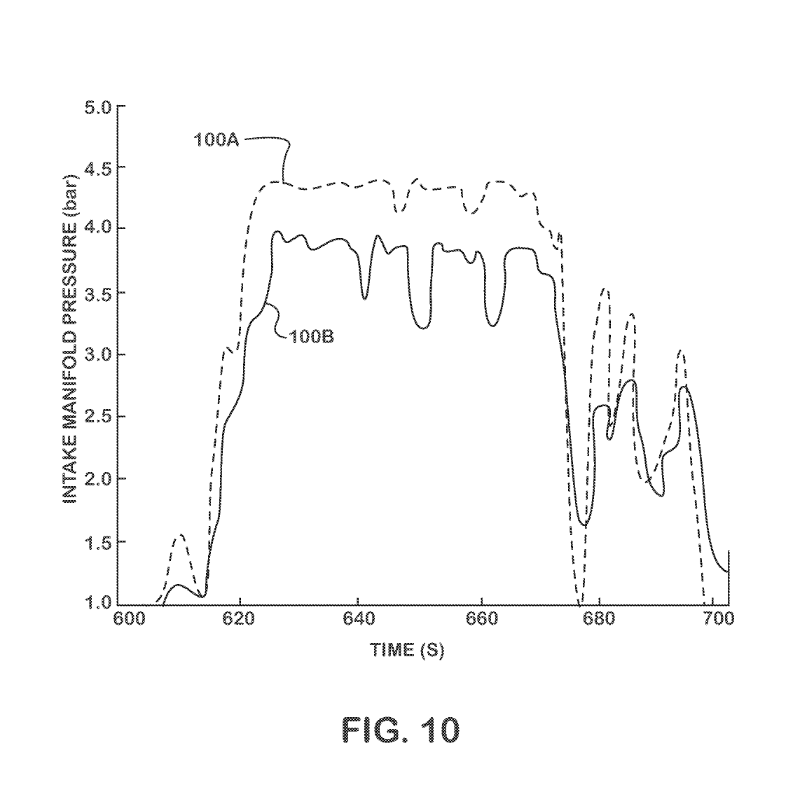

In FIG. 10 a time trace 100A represents intake manifold pressure, i.e. boost air, for the driven turbocharger configuration and a time trace 100B represents intake manifold pressure, i.e. boost air, for the non-driven turbocharger configuration. Comparison of traces 100A and 100B discloses that the driven turbocharger configuration provides more effective boost response.

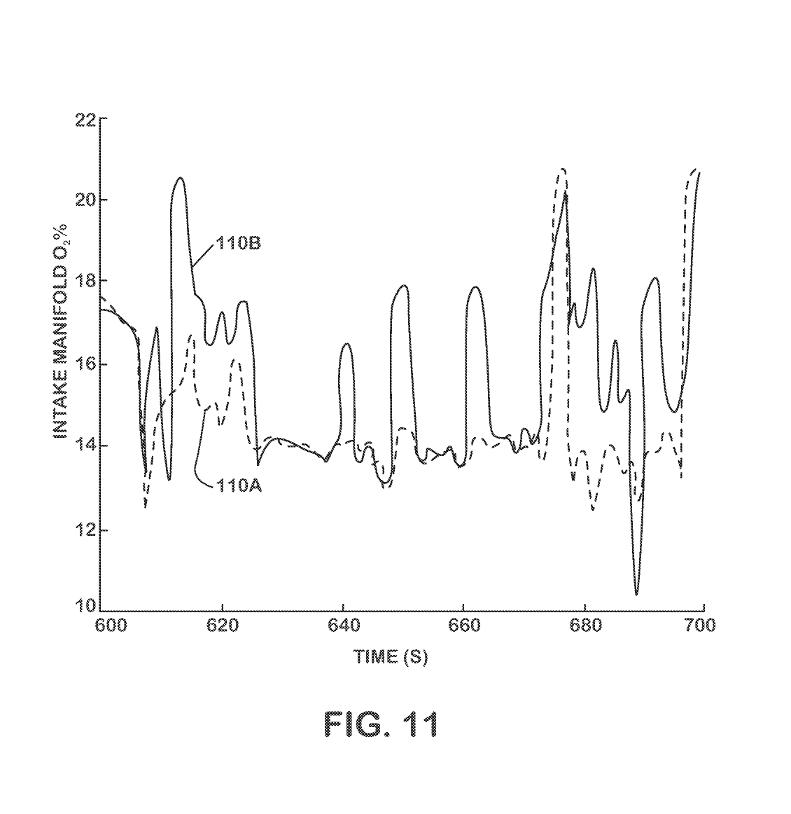

In FIG. 11 a time trace 110A represents oxygen percentage in the intake manifold for the driven turbocharger configuration and a time trace 110B represents oxygen percentage in the intake manifold for the non-driven turbocharger configuration. Comparison of traces 110A and 110B discloses that the driven turbocharger configuration provides a lower oxygen percentage in the intake manifold.

Because transients in engine operation can be contributors to increased constituents such as soot and oxides of nitrogen, the more effective response which is provided by a driven turbocharger configuration can aid in reducing those undesired constituents.

The disclosed strategy of controlling boost air by using a rotary device 56 to control power being applied to a compressor wheel can enable a power-control-based controller such as ECU 54 to control turbochargers having diverse architectures. In other words the disclosed strategy is independent of any particular turbocharger.

One example of a rotary device 56 is an electric motor/generator which, when operated as an electric motor, draws electricity from a source to add torque to the rotary turbocharger mechanism, and which when operated as an electric generator by the turbocharger turbine, generates electricity which may be immediately used and/or stored for future use. A mechanical device such as variable speed drive operatively coupled between the rotary turbocharger mechanism and the engine crankshaft can be used as rotary device 56.

What is claimed is:

1. An internal combustion engine comprising:
engine cylinders within which fuel is combusted to operate the engine;
an intake system, including an intake manifold, through which air enters the engine cylinders to support combustion;
an exhaust system through which exhaust resulting from combustion leaves the engine cylinders;
a turbocharger comprising a turbine in the exhaust system, a compressor in the intake system, and a rotary turbocharger mechanism operated by exhaust flow through the turbine for operating the compressor to compress air flow through the intake system and create pressure in the intake manifold exceeding ambient atmospheric pressure;
a rotary device coupled to the rotary turbocharger mechanism for selectively adding torque to and subtracting torque from the rotary turbocharger mechanism; and
a controller for processing, as the engine operates, data representing certain engine operating parameters according to an algorithm for calculating a quantity of power which the rotary drive is to selectively add to or subtract from power being produced by the turbine to cause the compressor to operate at a power level which creates a target pressure in the intake manifold different from existing pressure in the intake manifold, and for causing the rotary device to apply torque to the rotary turbocharger mechanism which causes the compressor to operate at the power level which creates the target pressure in the intake manifold different from existing pressure in the intake manifold.

2. A method of turbocharging an internal combustion engine which has engine cylinders within which fuel is combusted to operate the engine, an intake system, including an intake manifold, through which air enters the engine cylinders to support combustion, an exhaust system through which exhaust resulting from combustion leaves the engine cylinders, and a turbocharger comprising a turbine in the exhaust system, a compressor in the intake system, and a rotary turbocharger mechanism operated by exhaust flow through the turbine for operating the compressor to compress air flow through the intake system and create pressure in the intake manifold exceeding ambient atmospheric pressure, the method comprising:
controlling a rotary device coupled to the rotary turbocharger mechanism for selectively adding torque to and subtracting torque from the rotary turbocharger mechanism by processing, as the engine operates, data representing certain engine operating parameters according to an algorithm for calculating a quantity of power which the rotary drive is to selectively add to or subtract from power being produced by the turbine to cause the compressor to operate at a power level which creates a target pressure in the intake manifold different from existing pressure in the intake manifold; and
causing the rotary device to apply torque to the rotary turbocharger mechanism which causes the compressor to operate at the power level which creates the target pressure in the intake manifold different from existing pressure in the intake manifold.
